(19) United States
(12) Patent Application Publication
(10) Pub. No.: US 2010/0304058 A1
(43) Pub. Date: Dec. 2, 2010

(54) Non-drying label with thermal paper

(76) Inventor: Ziqing Li, Tianjin (CN)

Correspondence Address: ZHEN ZHENG LU, 1730 HUNTINGTON DRIVE #304, DUARTE, CA, 91010, US

(21) Appl. No.: 12/699,016

(22) Filed: Feb. 2, 2010

(30) Foreign Application Priority Data
Jun. 1, 2009 (CN) 200920096950.3

(51) Int. Cl. B41M 5/382

(52) U.S. Cl. 428/32.52

(57) ABSTRACT

A non-drying label with thermal paper, includes: thermal paper, forming a material of an upper surface of the non-drying label, having a first back adhesive layer; bottom paper, provided at lowest of the non-drying label, having a bottom spacing layer; and bearing paper, provided between the thermal paper and the bottom paper, having a second back adhesive layer. The thermal paper and the bottom paper adheres to the bearing paper via the back adhesive layers. An upper surface of the bearing paper has an information area, wherein the information area is applied with the parting silicone oil to form a transparent or translucent film spacing layer covered with the image and text information, and a joining area for adhering to the thermal paper via the first back adhesive layer, wherein the thermal paper is divided into a plurality of detachable portions corresponding to different areas of the bearing paper.

### BACKGROUND OF THE PRESENT INVENTION

1. Field of Invention

The present invention relates to a non-drying label, and more particularly to a non-drying label with thermal paper which sprays image and text information onto bearing paper, and covers the information area with parting silicone oil to make portions of the thermal paper corresponding to the information area separable, so as to display variable information and fixed information simultaneously.

2. Description of Related Arts

Non-drying labels are also called self-adhesive label, post-it note, or sticker. It is a composite material made by using paper, films or special materials as surface materials, applying adhesive onto the back of the surface materials to form a back adhesive layer, and using silicone coating protective paper as bottom paper. Then the composite material is processed by printing and die cutting to achieve product labels. When using, the label is peeled off the bottom paper and sticked to surfaces of various substrate materials with the back adhesive layer. Additionally, in manufacture the products can be labeled automatically in product line with labelling machine.

As comparing to conventional labels, the non-drying label does not need brushing glue, paste or water, is free of pollution, and saves time of labeling, and therefore can be conveniently and fast applied in various occasions. Labels with different surface materials, different adhesive in the back adhesive layer or different bottom paper can be applied to materials that ordinary paper label does not work. Printing of non-drying labels is much different from conventional printing. Non-drying labels are ordinarily printed and processed on label interlocking machines, and a plurality of working procedures are accomplished at a time, including image and text printing, die cutting, waste discharge, piece cutting or rewinding. That is to say, one end is the input of raw materials of whole winding, and the other end is the output of finished product. The finished product is classified into labels of single piece or whole winding, and can be directly applied to the commodities.

Nowadays, non-drying labels are indispensably applied in management of factory process, industrial labels, commercial logistics distribution, merchandise control, merchandise sales, after service and product traceability. In these fields, plural working procedures or links of commodity circulation frequently require the same label information which includes both of fixed information of image and text, and variable information such as barcode. At present, this kind of labels mainly adopt coated paper non-drying material to print fixed image and text information in label printers, or adopt carbon tape to print desired variable information such as barcode, and then applied to requiring procedures after die cutting into labels. Thus, fixed information and variable information can be recorded simultaneously in non-drying labels.

With the development of label materials and label printing technology, environment-friendly thermal printing technology and materials have appeared, which can clearly keep printed image and text for even 8-10 years. Due to the advantages of low cast and environmental friendliness, non-drying label with thermal paper takes place of traditional non-drying label which records information by printing with carbon tape containing lead. Thermal paper is a kind of special coated paper, which looks like ordinary white paper, but adopts ordinary paper as base and coats with a thermal color layer. The thermal color layer is coated on the surface of the ordinary paper, consists of adhesive, chromogenic reagent and colorless dye (otherwise called leuco dye), which are separated by microcapsule, and thus chemical reaction is latent. When the thermal paper meets heated printing head, the chromogenic reagent where is being printed reacts with the colorless dye to change color and form image and text.

FIG. 1 is a sectional schematic view of a non-drying label with thermal paper according to prior art.

Referring to FIG. 1, the non-drying label with thermal paper according to prior art includes: thermal paper 1 for forming a material of an upper surface of the non-drying label, wherein information is printed on an upper surface of the thermal paper 1 with a thermal printer, having a first back adhesive layer 3 formed by applying adhesive onto a lower surface of the thermal paper 1; and bottom paper 2, provided on lowest of the non-drying label, having a bottom spacing layer 4 formed by applying parting silicone oil onto an upper surface of the bottom paper 2, wherein the thermal paper and the bottom paper adheres to each other via the first back adhesive layer 3.

However, the foregoing prior has the following drawbacks:

In the above non-drying label with thermal paper according to prior art, the information recorded on the surface material formed by the thermal paper is relatively limited, and the label can not display fixed information and variable information simultaneously. Additionally, the information recorded on the surface of the thermal paper can not be changed without damaging the label. Therefore, the non-drying label with thermal paper can not be applied in situations that information of label needs to be changed according to different procedures, and application of the product is much limited.

### SUMMARY OF THE PRESENT INVENTION

An object of the present invention is to provide a non-drying label with thermal paper which sprays image and text information onto bearing paper, and covers the information area with parting silicone oil to make portions of thermal paper corresponding to the information area separable, so as to display variable information and fixed information simultaneously.

Another object of the present invention is to provide a non-drying label with thermal paper which is capable of changing information recorded thereon without damaging the non-drying label.

Another object of the present invention is to provide a non-drying label with thermal paper which is particularly adapted for situations that the information needed to be recorded on the thermal paper is multiple in procedures, or variable information replaces each other in turn.

Another object of the present invention is to provide a non-drying label with thermal paper which does not involve complicated structure or high executing cost to achieve the above objects, so the non-drying label display variable information and fixed information simultaneously to meet various requirements.

Accordingly, in order to accomplish the above objects, the present invention provides a non-drying label with thermal paper, comprising:

thermal paper, forming a material of an upper surface of the non-drying label, wherein information is printed on an upper surface of the thermal paper with a thermal printer, having a first back adhesive layer formed by applying an adhesive onto a lower surface of the thermal paper;

bottom paper, provided at lowest of the non-drying label, having a bottom spacing layer formed by applying parting silicone oil onto an upper surface thereof; and

bearing paper, provided between the thermal paper and the bottom paper, having a second back adhesive layer formed by applying the adhesive onto a lower surface thereof, wherein the thermal paper and the bottom paper adheres to the bearing paper via the first back adhesive layer and the second back adhesive layer;

wherein an upper surface of the bearing paper has an information area for printing or spraying image and text information, wherein the information area is applied with the parting silicone oil to form a transparent or translucent film spacing layer covered with the image and text information, and a joining area for adhering to the thermal paper via the first back adhesive layer, wherein the thermal paper is divided into a plurality of detachable portions corresponding to different areas of the bearing paper.

The present invention can also be embodied as the following:

The parting silicone oil applied onto the upper surface of the bearing paper is solventless parting silicone oil or UV (ultraviolet) cured parting silicone oil.

The parting silicone oil applied onto the upper surface of the bearing paper is processed with dyeing.

The bearing paper is Glassin base paper or materials of plastic film and synthetic paper.

A first portion of the thermal paper which corresponds to the information area has an edge applied with white printing ink.

The adhesive of the first back adhesive layer and the second back adhesive layer adopts factice, water gel or hot melt adhesive.

The first portion of the thermal paper corresponding to the information area is divided into a plurality of detachable portions.

The present invention has the following advantages and positive effects:

In the non-drying label with thermal paper according to the present invention, the bearing paper is provided between the thermal paper and the bottom paper, and adheres to the thermal paper and the bottom paper respectively. The bearing paper has the information area and the joining area. In the information area, printing ink can be used to print relatively fixedly used image and text information, and transparent or translucent parting silicone oil is used to cover the information area, so as to make the first portion of the thermal paper which corresponds to the information area detach from the bearing paper easily to expose the information area on the bearing paper which records the image and text information. Oppositely, a second portion of the thermal paper which adhering to the joining area combines with the bearing paper firmly, and image and text information can be printed on the thermal paper directly, so as to greatly increase information content of the non-drying label can carry. Further, information recorded on the non-drying label can be changed at any time according to particular requirements, so as to simultaneously display variable information and fixed information of product, and make the information recorded on the non-drying label more accurate.

These and other objectives, features, and advantages of the present invention will become apparent from the following detailed description, the accompanying drawings, and the appended claims.

### BRIEF DESCRIPTION OF THE DRAWINGS

FIG. 1 is a sectional schematic view of a non-drying label with thermal paper according to prior art.

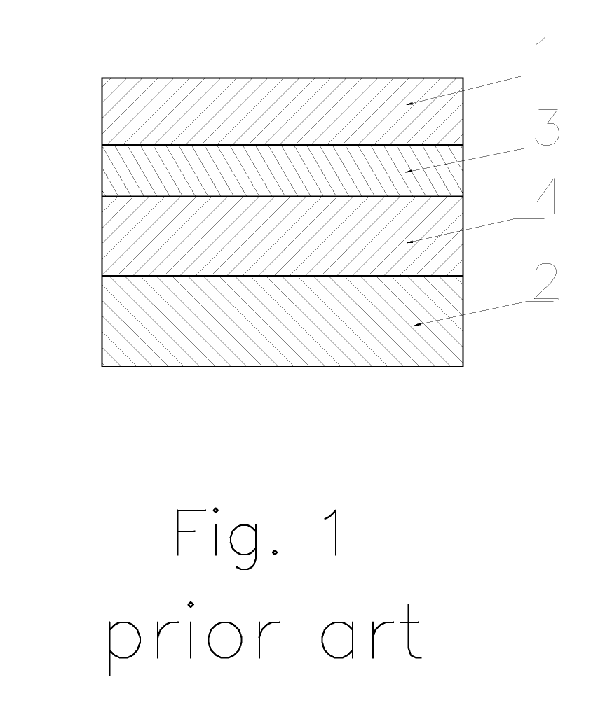

FIG. 2 is a sectional schematic view of a non-drying label with thermal paper according to a preferred embodiment of the present invention.

FIG. 3 is a planform view of the non-drying label with thermal paper according to the preferred embodiment of the present invention.

### DETAILED DESCRIPTION OF THE PREFERRED EMBODIMENT

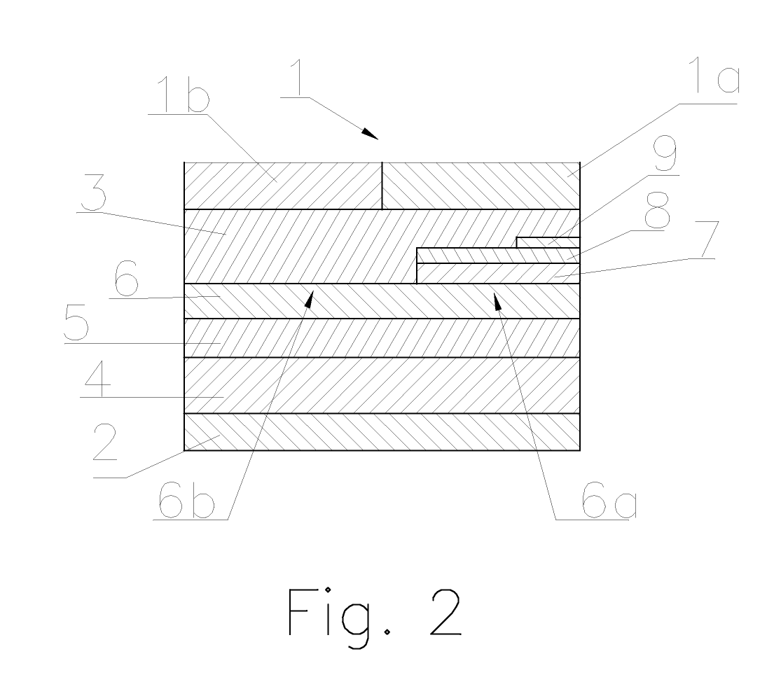

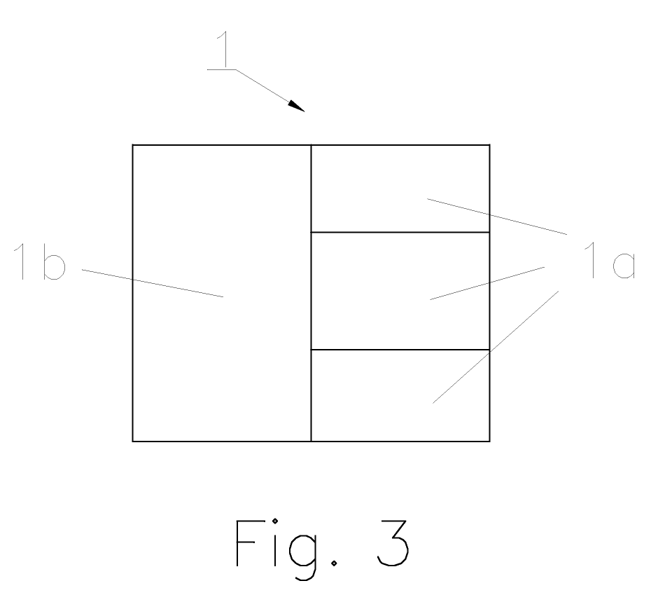

Referring to FIG. 2-3 of the drawings, a non-drying label with thermal paper according to a preferred embodiment of the present invention is illustrated, comprising thermal paper 1, bottom paper 2 and bearing paper 6.

The thermal paper 1 forms a material of an upper surface of the non-drying label. Information can be printed on an upper surface of the thermal paper 1 with a thermal printer. The thermal printer is more convenient and environment-friendly than a traditional printer. The thermal paper 1 has a first back adhesive layer 3, which is formed by applying an adhesive onto a lower surface of the thermal paper 1.

The bottom paper 2 is at lowest of the non-drying label, and has a bottom spacing layer 4, which is formed by applying parting silicone oil onto an upper surface of the bottom paper 2. The bottom spacing layer 4 makes adhesion of the bottom paper 2 and the first back adhesive layer 3 not too tightly, so the bottom paper 2 can be detached conveniently in use and adhere the non-drying label to objects.

The bearing paper 6 has a second adhesive layer 5, which is formed by applying the adhesive onto a lower surface of the bearing paper 6. The thermal paper 1 and the bottom paper 2 respectively adhere to the bearing paper 6 via the first back adhesive layer 3 and the second adhesive layer 5. The bearing paper 6 becomes a middle layer of the non-drying label to carry fixed information.

The upper surface of the bearing paper 6 is divided into an information area 6a and a joining area 6b. Image and text information is printed or sprayed in the information area, and forms a printing ink layer 7 on the bearing paper 6 with printing ink which records information. At the same time, parting silicone oil is applied onto the information area 6a of the upper surface of the bearing paper 6, so as to form a transparent or translucent film spacing layer 8 covering the image and text information. The film spacing layer 8 makes the information area 6a of the bearing paper 6 and a position-corresponding first portion 1a of the thermal paper 1 detach according to particular situations, so as to accomplish substitution of information. After the first portion 1a of the thermal paper 1 above the information area 6a is removed, the fixed information on the bearing paper 6 exposes.

The joining area 6b adheres to the thermal paper 1 via the first back adhesive layer 3, is a portion of the upper surface of the bearing paper 6. In the joining area, the thermal paper 1 and the bearing paper 6 combines firmly and can not be detached easily. The thermal paper 1 is divided into a plurality of detachable portions corresponding to different portions of the bearing paper 6. Therefore the first portion 1a of the thermal paper 1 corresponding to the information area 6a is removable in use, so as to expose the fixed image and text information printed on the bearing paper 6.

The parting silicone oil applied onto the upper surface of the bearing paper 6 is solventless parting silicone oil or ultraviolet cured parting silicone oil, so as to reduce pollution of the parting silicone oil and be environment-friendly.

The parting silicone oil applied onto the upper surface of the bearing paper 6 is processed with dyeing. The parting silicone oil by color paste dyeing, which is applied locally onto the bearing paper 6, is capable of effectively reducing blanks when locally applying. In working procedures, an amount of applying is judged and controlled by color of applied dyed parting silicone oil, so as to avoid blanks and unevenness in locally applying the parting silicone oil onto parting bearing paper. Besides, in quality control parting force of the non-drying label can be tested conveniently. Under light of backlights, bottom of the non-drying label has clear colors, and areas of applied with parting silicone oil or not can be told by naked eye, so as to provide a more convenient and easier method of quality control. The bearing paper 6 is Glassin base paper or materials of plastic film (PP, PE, PET) and synthetic paper to obtain corresponding strength for avoiding damage.

The first portion 1a of the thermal paper 1 corresponding to the information area 6a has an edge applied with white printing ink 9. The white printing ink 9 can separate adhesion between the film spacing layer 8 and the first back adhesive layer 3. Therefore, the first portion 1a of the thermal paper 1 corresponding to the information area 6a is easier to be detached in use.

The adhesive of the first back adhesive layer 3 and the second back adhesive layer 5 adopts factice, water gel or hot melt adhesive, and preferably adopts environment-friendly material when ensuring adhesive effect of all layers of the non-drying label.

The first portion 1a of the thermal paper 1 corresponding to the information area 6a is divided into a plurality of detachable portions for particular situations that the information needed to be recorded on the thermal paper 1 is multiple in procedures, or variable information replaces each other in turn.

In the non-drying label with thermal paper according to the present invention, the bearing paper 6 is provided between the thermal paper 1 and the bottom paper 2, and adheres to the thermal paper 1 and the bottom paper 2 respectively. The bearing paper 6 has the information area 6a and the joining area. In the information area 6a, printing ink can be used to print relatively fixedly used image and text information, and transparent or translucent parting silicone oil is used to cover the information area 6a, so as to make the first portion 1a of the thermal paper 1 which corresponds to the information area 6a detach from the bearing paper 6 easily to expose the information area 6a on the bearing paper 6 which records the image and text information. Oppositely, a second portion 1b of the thermal paper 1 which adhering to the joining area combines with the bearing paper 6 firmly, and image and text information can be printed on the thermal paper 1 directly, so as to greatly increase information content of the non-drying label can carry. Further, information recorded on the non-drying label can be changed at any time according to particular requirements, so as to simultaneously display variable information and fixed information of product, and make the information recorded on the non-drying label more accurate.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A non-drying label with thermal paper, comprising:
thermal paper, forming a material of an upper surface of said non-drying label, for printing information on an upper surface of said thermal paper with a thermal printer, having a first back adhesive layer formed by applying an adhesive onto a lower surface of said thermal paper;
bottom paper, provided at lowest of said non-drying label, having a bottom spacing layer formed by applying parting silicone oil onto an upper surface thereof; and
bearing paper, provided between said thermal paper and said bottom paper, having a second back adhesive layer formed by applying said adhesive onto a lower surface of said bearing paper, wherein said thermal paper and said bottom paper adheres to said bearing paper via said first back adhesive layer and said second back adhesive layer;
wherein an upper surface of said bearing paper has an information area for printing or spraying image and text information, wherein said information area is applied with said parting silicone oil to form a transparent or translucent film spacing layer covered with the image and text information, and a joining area for adhering to said thermal paper via said first back adhesive layer, wherein said thermal paper is divided into a plurality of detachable portions corresponding to different areas of said bearing paper.

2. The non-drying label, as recited in claim 1, wherein said parting silicone oil applied onto said upper surface of said bearing paper is selected from the group consisting of solventless parting silicone oil and ultraviolet cured parting silicone oil.

3. The non-drying label, as recited in claim 1, wherein said parting silicone oil applied onto said upper surface of said bearing paper is processed with dyeing.

4. The non-drying label, as recited in claim 2, wherein said parting silicone oil applied onto said upper surface of said bearing paper is processed with dyeing.

5. The non-drying label, as recited in claim 1, wherein said bearing paper is selected from the group consisting of Glassin base paper and materials of plastic film and synthetic paper.

6. The non-drying label, as recited in claim 2, wherein said bearing paper is selected from the group consisting of Glassin base paper and materials of plastic film and synthetic paper.

7. The non-drying label, as recited in claim 4, wherein said bearing paper is selected from the group consisting of Glassin base paper and materials of plastic film and synthetic paper.

8. The non-drying label, as recited in claim 1, wherein a first portion of said thermal paper which corresponds to said information area has an edge applied with white printing ink.

9. The non-drying label, as recited in claim 2, wherein a first portion of said thermal paper which corresponds to said information area has an edge applied with white printing ink.

10. The non-drying label, as recited in claim 5, wherein a first portion of said thermal paper which corresponds to said information area has an edge applied with white printing ink.

11. The non-drying label, as recited in claim 7, wherein a first portion of said thermal paper which corresponds to said information area has an edge applied with white printing ink.

12. The non-drying label, as recited in claim 1, wherein said adhesive of said first back adhesive layer and said second back adhesive layer is selected from the group consisting of factice, water gel and hot melt adhesive.

13. The non-drying label, as recited in claim 2, wherein said adhesive of said first back adhesive layer and said second back adhesive layer is selected from the group consisting of factice, water gel and hot melt adhesive.

14. The non-drying label, as recited in claim 5, wherein said adhesive of said first back adhesive layer and said second back adhesive layer is selected from the group consisting of factice, water gel and hot melt adhesive.

15. The non-drying label, as recited in claim 11, wherein said adhesive of said first back adhesive layer and said second back adhesive layer is selected from the group consisting of factice, water gel and hot melt adhesive.

16. The non-drying label, as recited in claim 1, wherein said first portion of said thermal paper corresponding to said information area is divided into a plurality of detachable portions.

17. The non-drying label, as recited in claim 2, wherein said first portion of said thermal paper corresponding to said information area is divided into a plurality of detachable portions.

18. The non-drying label, as recited in claim 5, wherein said first portion of said thermal paper corresponding to said information area is divided into a plurality of detachable portions.

19. The non-drying label, as recited in claim 11, wherein said first portion of said thermal paper corresponding to said information area is divided into a plurality of detachable portions.

20. The non-drying label, as recited in claim 15, wherein said first portion of said thermal paper corresponding to said information area is divided into a plurality of detachable portions.
